(19) United States
(12) Patent Application Publication
(10) Pub. No.: US 2014/0028947 A1
(43) Pub. Date: Jan. 30, 2014

(54) Liquid Crystal Display Device, Backlight Module, and Backframe

(71) Applicants: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(72) Inventors: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(73) Assignee: SHENZHEN CHINA STAR OPTOELECTRONICS TECHNOLOGY CO. LTD., Shenzhen (CN)

(21) Appl. No.: 13/579,036

(22) PCT Filed: Jul. 25, 2012
(86) PCT No.: PCT/CN12/79134

§ 371 Date: Aug. 15, 2012

(30) Foreign Application Priority Data
Jul. 24, 2012 (CN) 201210257804.0

(51) Int. Cl. G02F 1/1333

(52) U.S. Cl. CPC G02F 1/133308
USPC 349/58

(57) ABSTRACT

The present invention discloses a backframe, and the backframe includes a supporting bracket configured with a bottom board, a sidewall and a dam portion. Wherein the bottom board is interconnected with the sidewall so as to support an optical arrangement of the backlight module, wherein the dam portion is arranged on the sidewall in a position distant to the bottom board for supporting a liquid crystal display panel. Wherein the bottom board, the sidewall and the dam portion are jointly defining a receiving slot for receiving a side portion of the optical arrangement. And a bent portion interconnected to the dam portion to position the liquid crystal display panel along with the dam portion. The present invention further discloses a liquid crystal display module and backlight module incorporated therein. With the disclosure of the present invention, the plastic frame is omitted and the manufacturing cost and material cost are both reduced. Eventually, the cost of the final product is also reduced.

### FIELD OF THE INVENTION

The present invention relates to a technical field of liquid crystal, and more particularly to a liquid crystal display device, a backlight module incorporated therein, and a backframe

### DESCRIPTION OF PRIOR ART

A liquid crystal display, also known as LCD is a kind of flat panel display (FPD) device which utilizes the characteristics of the liquid crystal to display patterns and figures. As compared, to the conventional displaying device, such as the cathode ray tube, it the LCD features a slim, compact, low driving voltage and low energy consumption. As such, the LCD has become the main stream of the displaying market, specially in the consumer electronic market. However, as known to the skilled in the art, that the liquid crystal display can not generate or emit light by itself and an external light source has to be incorporated so as to illuminate the liquid crystal display. Currently, a backlight module is used to provide illumination to the liquid crystal display device.

Referring now to FIG. 1, which is an illustrational and structural view of a conventional liquid crystal display (LCD) device. The LCD device includes a panel 110. an optical arrangement 111, a plastic frame 112, and a backframe 113. The backframe 113 has an L-shaped configuration used to support and receive the optical arrangement 111. The plastic frame 112 is disposed within the backframe 113, and is used to position the optical arrangement 111 and support further the panel 110 together with the backframe 113. The plastic frame 112 and the backframe 113 are two individually created parts, and they have to be made with different molds. Accordingly, this practice inevitably increases the cost of the manufacturing, as well as assembling.

### SUMMARY OF THE INVENTION

It is the object of the present invention to provide a liquid crystal display device, its backlight module as well as its backframe. In the genuine configuration, a conventional plastic frame is omitted so as to reduce the overall cost.

In order to resolve the technical, issue encountered by the prior art, the present invention introduce a technical solution by providing a backframe incorporated with a backlight module, and wherein the backframe includes a supporting bracket configured with a bottom board, a sidewall and a dam portion. Wherein the bottom board is interconnected with the sidewall so as to support an optical arrangement of the backlight module. Wherein the dam portion is arranged on the sidewall in a position distant to the bottom board for supporting a liquid crystal display panel wherein the bottom board, the sidewall and the dam portion are jointly defining a receiving slot for receiving a side portion of the optical arrangement. And a bent portion interconnected to the dam portion to position the liquid crystal display panel along with the dam portion.

Wherein the bent portion extends from the dam portion and bending away from the dam portion and toward the receiving slot so as to juxtapose to a side of the liquid crystal display panel.

Wherein the bent portion is formed by cut-out portion of the dam portion.

Wherein there is a plurality of bent portions alternatively arranged on the dam portion.

Wherein an elastic element is arranged between the bent portion and the side of the liquid crystal display panel.

Wherein an elastic element is arranged between the dam portion and the optical arrangement so as to prevent a transversal movement of the optical arrangement that is in parallel to a line drawn between the darn portion and the bottom board.

Wherein the supporting bracket is configured by a plurality interconnected units, each of the units is provided with a fixture to position the optical arrangement together with the bottom board.

In order to resolve the technical issue encountered by the prior art, the present invention introduce a technical solution by providing a backlight module configured with an optical arrangement and a backframe, wherein the backframe includes a supporting bracket configured with a bottom board, a sidewall and a dam portion. Wherein the bottom board is interconnected with the sidewall so as to support an optical arrangement, wherein the dam portion is arranged on the sidewall in a position distant to the bottom board for supporting a liquid crystal display panel. Wherein the bottom board, the sidewall and the dam portion are jointly defining a receiving slot for receiving a side portion of the optical arrangement. And a bent portion interconnected to the dam portion to position the liquid crystal display panel along with the dam portion. And wherein the supporting bracket is configured by a plurality interconnected units so as to define a receiving space, wherein the optical arrangement is disposed within the receiving space.

Wherein the bent portion extends from the dam portion and bending away from the dam portion and toward the receiving slot so as to juxtapose to a side of the liquid crystal display panel.

Wherein the bent portion is formed by cut-out portion of the dam portion,

Wherein there is a plurality of bent portions alternatively arranged on the dam portion.

Wherein, an elastic element is arranged between the bent portion and the side of the liquid crystal display panel.

Wherein an elastic element is arranged between the dam portion and the optical arrangement so as to prevent a transversal movement of the optical arrangement that is in parallel to a line drawn between the dam portion and the bottom board.

Wherein the supporting bracket is configured by a plurality interconnected units, each of the units is provided with a fixture to position the optical arrangement together with the bottom board.

In order to resolve the technical issue encountered by the prior art, the present invention introduce a technical solution by providing a liquid crystal display device, wherein the device includes a panel and a backlight module. Wherein there is a plurality of bent portions closely juxtaposed with multiple sides of the panel so as to position the panel.

According to the embodiment of the present invention, the optical arrangement of the backlight module is preferably supported by the bottom board of the backframe, while the dam portion to support the liquid crystal display panel and further a bent portion from the dam portion to position the liquid crystal display panel. As such, the plastic frame widely used in the prior art is omitted. It is therefore beneficially reduce the use of mold as well, as material cost. In turn, the overall product is also benefited with reduced manufacturing cost.

### BRIEF DESCRIPTION OF DRAWINGS

FIG. 1 is an illustrational and structural view of a conventional liquid crystal display (LCD) device:

FIG. 2 is an illustration and structural view of a liquid crystal display device incorporated with a backframe of the present invention;

FIG. 3 is a perspective and illustrational view of a supporting bracket and a bent portion of the backframe shown in FIG. 2;

FIG. 4 is an illustrational and structural view of a backlight module made in accordance with a preferred embodiment of the present invention; and

FIG. 5 is an illustrational and structural view of a liquid crystal display device made in accordance with a preferred embodiment of the present invention.

### DETAILED DESCRIPTION OF PREFERRED EMBODIMENT

Detailed description will be given with preferred embodiment along with the accompanied drawings.

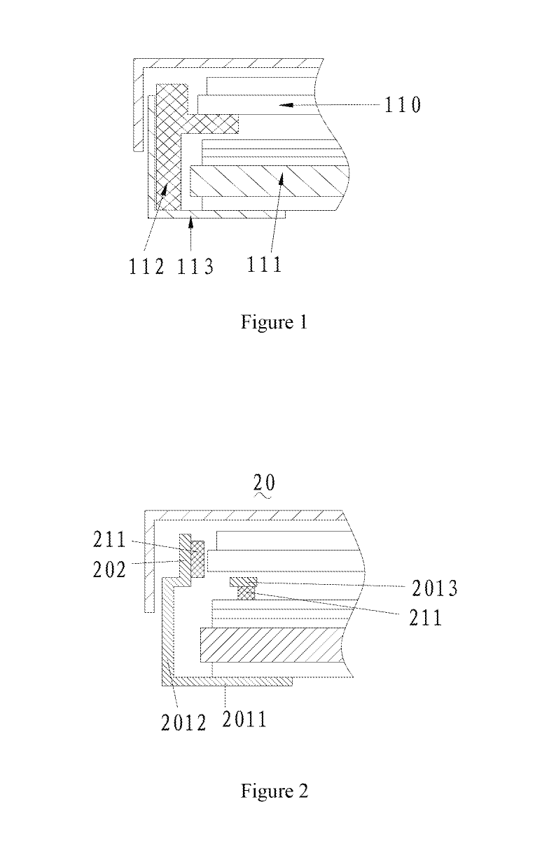

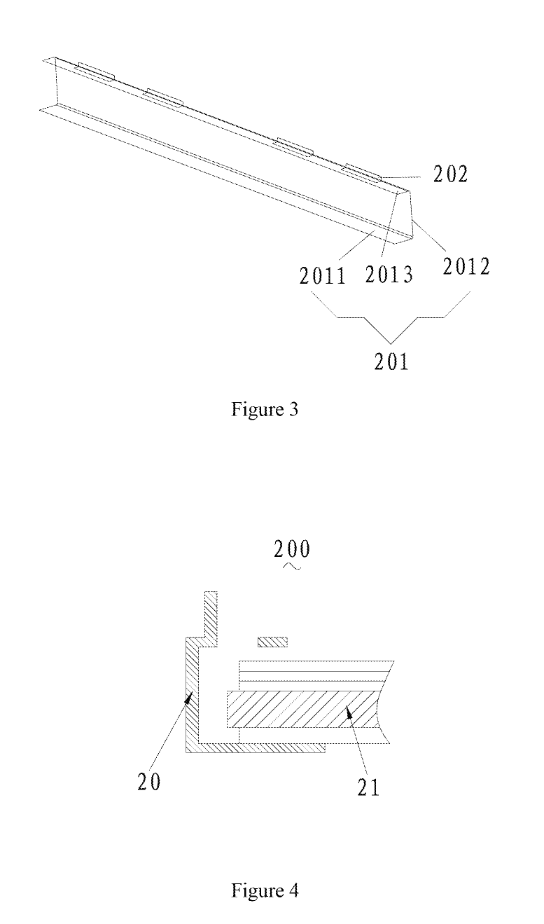

FIG. 2 is an illustration and structural view of a liquid crystal display device incorporated with a backframe of the present invention; and FIG. 3 is a perspective and illustrational view of a supporting bracket and a bent portion of the backframe shown in FIG. 2.

In the current embodiment, the backframe 20 includes a supporting bracket 201, and a bent portion 202. Of course, it should be noted that the backframe 20 is not limited with merely those elements, other necessary parts can also be included if required.

The supporting bracket 201 is used to support and receive an optical arrangement. Substantially, the supporting bracket 201 includes a bottom board 2011, a sidewall 2012, and a dam portion 2013. The bottom board 2011 is interconnected with the sidewall 2012 with one end. The bottom board 2011 is used to support the optical arrangement of the backlight module. The dam portion 2013 is disposed on the sidewall 2012 in a position distant and away from the bottom board 2011 so as to support the liquid crystal display panel. In addition, an elastic element 211 can be arranged between the dam portion 2013 and the optical arrangement of the optical arrangement so as to prevent the optical arrangement from creating a transversal movement that is in parallel to a line drawn between the dam portion 2013 and the bottom board 2011. This will further ensure to prevent the optical arrangement from being scratched by the backframe 20. Furthermore, the bottom board 2011, the sidewall 2012, and the dam portion 2013 jointly define a horizontal U-shaped receiving slot for .receiving the side of the optical arrangement.

The bent portion 202 is generated by folding a cut-out portion from the dam portion 2013. Substantially, the bent portion 202 is folding out from the dam portion 2013 in a direction which is away from the receiving slot so as to juxtapose to the side of the liquid crystal display panel. With the cooperation of the bent portion 202 and the dam portion 2013. the transversal movement of the liquid crystal display panel along the horizontal direction can be limited. In addition, the dam portion 2013 is also supporting the liquid crystal display panel, and thereby securely positioning the panel, in the present embodiment, there are totally four (4) bent portions 202, and are arranged in pair across the dam portion 2013. Of course, the arrangement of the bent portion 202 should not be limited to one or multiple, while it can be readily decided according to the field requirements. Meanwhile, the elastic element 211 arranged between the bent portion 202 and the sides of the panel is used to prevent the panel from being damaged by the bent portion 202. It should be noted that the elastic element can be selected from a soft plastic or rubber pad.

The backframe 20 can be configured by plurality of supporting bracket 201 interconnected with head-to-tail arrangement. The bottom board 2011 of the supporting bracket 201 is arranged with fixture (not shown in Figure) so as to position the optical arrangement along with the bottom board 2011. In the current embodiment, there are four supporting brackets 201, and those four supporting bracket 201 can be interlinked by hinges or screws so as to configure a rectangular configuration. In addition, the supporting bracket 201 can be further overlapped with another supporting bracket 201 rotationally folding arrangement. By this, the overall volume of the backframe 20 is substantially reduced during transportation. The fixture can be embodied as a single one or a multiple juxtaposed arrangement. With the ends of the fixture attached to the plurality of the bottom board 2011 of the supporting bracket, the optical arrangement can be further secured. It should not be limited to any of the examples described above. Furthermore, in the current embodiment, the supporting bracket 203 and the bent portion 202 are integrally formed to configure the backframe 20. As a result, a single mold can meet all the requirements thereby reducing the manufacturing cost. The backframe 20 can be made from aluminum sheet or galvanized steel sheet.

FIG. 4 is an illustrational and structural view of a backlight module made in accordance with a preferred embodiment of the present invention.

In this embodiment, the backlight module 200 is used to provide luminous light source to the liquid crystal display panel. The backlight module 200 includes, but not limited, a backframe 20, and an optical arrangement 21. The backframe 20 is used to contain and position the optical arrangement 21 which is configured with a waveguide and optical films. Substantially, the backframe 20 includes a plurality of supporting brackets 201 which are interlinked with head-to-tail manner so as to define a receiving space in a way that the optical arrangement 21 can be disposed within the receiving space. The plurality of bottom board 2011 of the supporting brackets 201 are provided with the fixture described above, it should be noted that the fixture can be embodied as a screw or rivet, and it should not be limited to what disclosed above. The bottom board 2011 can be used to position the optical arrangement 21 by means of the fixture.

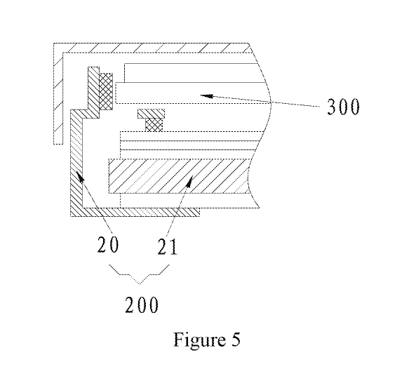

FIG. 5 is an illustrational and structural view of a liquid crystal display device made in accordance with a preferred embodiment of the present invention. The liquid crystal display device generally includes a backlight module 200. and a liquid crystal display panel 300. It should be noted that the display device can include additional elements and parts according to design requirement Wherein, the backframe 20 is arranged with one or more bent portion 202, and the bent portion 202 is further arranged to juxtapose to the side of the display panel 300 so as to securely position the display panel 300.

From the foregoing description of the embodiment of the present invention, the optical arrangement of the backlight module is preferably supported by the bottom board of the backframe, while the dam portion to support the liquid crystal display panel and further a bent portion from the dam portion to position the liquid crystal display panel. As such, the plastic frame widely used in the prior art is omitted. It is therefore beneficially reduce the use of mold as well as material cost. In turn, the overall product is also benefited with reduced manufacturing cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A backframe incorporated with a backlight module, and wherein the backframe includes:
A supporting bracket configured with a bottom board, a sidewall and a dam portion, wherein the bottom board is interconnected with the sidewall so as to support an optical arrangement of the backlight module, wherein the dam portion is arranged on the sidewall in a position distant to the bottom board for supporting a liquid crystal display panel, wherein the bottom board, the sidewall and the dam portion are jointly defining a receiving slot for receiving a side portion of the optical arrangement; and
A bent portion interconnected to the dam portion to position the liquid crystal display panel along with the dam portion.

2. The backframe as recited in claim 1, wherein the bent portion extends from the dam portion and bending away from the dam portion and toward the receiving slot so as to juxtaposed to a side of the liquid crystal display panel.

3. The backframe as recited in claim 2, wherein the bent portion is formed by cut-out portion of the dam portion.

4. The backframe as recited in claim 3, wherein there is a plurality of bent portions alternatively arranged on the dam portion.

5. The backframe as recited in claim 4, wherein an elastic element is arranged between the bent portion and the side of the liquid crystal display panel.

6. The backframe as recited in claim 1, wherein an elastic element is arranged between the dam portion and the optical arrangement so as to prevent a transversal movement of the optical arrangement that is in parallel to a line drawn between the dam portion and the bottom board.

7. The backframe as recited in claim 1, wherein the supporting bracket is configured by a plurality interconnected units, each of the units is provided with a fixture to position the optical arrangement together with the bottom board.

8. A backlight module configured with an optical arrangement and a backframe, wherein the backframe includes:
A supporting bracket configured with a bottom board, a sidewall and a dam portion, wherein the bottom board is interconnected with the sidewall so as to support an optical arrangement, wherein the dam portion is arranged on the sidewall in a position distant to the bottom board for supporting a liquid crystal display panel, wherein the bottom board, the sidewall and the dam portion are jointly defining a receiving slot for receiving a side portion of the optical arrangement; and
A bent portion interconnected to the dam portion to position the liquid crystal display panel along with the dam portion; and
Wherein the supporting bracket is configured by a plurality interconnected units so as to define a receiving space, wherein the optical arrangement is disposed within the receiving space.

9. The backlight module as recited in claim 8, wherein the bent portion extends from the dam portion and bending away from the dam portion and toward the receiving slot so as to juxtaposed to a side of the liquid crystal display panel.

10. The backlight module as recited in claim 9, wherein, the bent portion is formed by cut-out portion of the dam portion.

11. The backlight module as recited in claim 11, wherein there is a plurality of bent portions alternatively arranged on the dam portion.

12. The backlight module as recited in claim 11, wherein an elastic element is arranged between the bent portion and the side of the liquid crystal display panel.

13. The backlight module as recited in claim 13, wherein an elastic element is arranged between the dam portion and the optical arrangement so as to prevent a transversal movement of the optical arrangement that is in parallel to a line drawn between the dam portion and the bottom board.

14. The backlight module as recited in claim 1, wherein, the supporting bracket is configured by a plurality interconnected units, each of the units is provided with a fixture to position the optical arrangement together with the bottom board.

15. A liquid crystal display device, wherein the device includes a panel and a backlight module recited in claim 8, wherein there is a plurality of bent portions closely juxtaposed with multiple sides of the panel so as to position the panel.
